(19) United States
(12) Patent Application Publication
(10) Pub. No.: US 2008/0278422 A1
(43) Pub. Date: Nov. 13, 2008

(54) Field method of PWM for LED display, and LED display implementing the same

(75) Inventors: Baiqiang Xu, Naperville, IL (US); Frank John Kraszewski, Mundelein, IL (US)

Correspondence Address: NIXON & VANDERHYE, PC, 901 NORTH GLEBE ROAD, 11TH FLOOR, ARLINGTON, VA, 22203, US

(73) Assignee: Paltronics, Inc., Crystal Lake, IL (US)

(21) Appl. No.: 11/797,964

(22) Filed: May 9, 2007

(51) Int. Cl. G09G 3/32

(52) U.S. Cl. 345/83

(57) ABSTRACT

Systems and/or methods for displaying content on an LED display device comprising a plurality of LED modules are provided. A plurality of frames to be sequentially displayed on the LED display device across the plurality of LED modules may be defined based at least in part on the content to be displayed. A fieldcount corresponding to a number of scans appropriate for each said frame may be defined. For each said frame, the fieldcount for the frame may be initialized. The frame may be divided into a plurality of sequentially ordered rows and columns. For each said row, in sequence, a signal may be outputted to the LED display device in dependence on the frame, the fieldcount, the row, and the column. The fieldcount may be increased and the dividing step may be repeated until all scans of the frame have been completed. The content may be displayable substantially continuously and substantially free from flickers.

### TECHNICAL FIELD

The exemplary embodiments described herein relate to systems and/or methods for updating displays and, more particularly, to systems and/or methods that implement a frame-based update technique for displaying content (e.g., text, images, and/or like media in motion) on one or more light emitting diode (LED) modules in an LED display. In certain exemplary embodiments, the LED modules may be electrically connected in series. The exemplary embodiments described herein may be applicable for incorporation into electronic gaming machines and/or progressive jackpot gaming systems. It will be appreciated that the exemplary embodiments described herein may be applied to other types of display devices in place of, or in addition to, LED modules, including, for example, CRT display devices, LCD display devices, etc.

### BACKGROUND AND SUMMARY

Display devices have been used for years to convey messages, provide entertainment through various forms of media, etc. One conventional display device that has been used is the LED module. Such LED modules have been used, for example, to display scrolling text messages. LED modules have advanced from simple, single color displays capable of displaying only simple messages to more advanced devices capable of displaying multi-colored text, images, and/or like media in motion across a plurality of LED modules comprising an LED display. Typically, control hardware is provided to an LED display device, organized so that all of the LEDs in a single row are driven simultaneously and so that the rows are driven one at a time, in sequence. This technique has been used successfully to reduce the component cost of the LED display.

To produce a stable and flicker-free image, the following technique is commonly used. The human eye generally will not perceive the on/off cycles of an LED if the LED is cycled (e.g., turned on and off) at a rate faster than 60 times per second. This phenomenon can used to provide intensity control where the LEDs can be either on or off by controlling the portion of the on/off cycle (also sometimes referred to simply as the cycle) during which the LEDs are on. For example, an LED that is turned on for one-half of the cycle will appear one-half as bright as one turned on for the entire cycle, or an LED turned on for one-eighth the cycle will appear one-half as bright as one turned on for one-fourth of the cycle.

It will be appreciated that the relative intensity is, in essence, determined by the ratio of on time to maximum on time. As an example, an LED display with 8 rows of LEDs has a maximum on time of one-eighth the cycle time. Intensity control is achieved by further subdividing the maximum on time interval. The number of divisions is determined by the number of desired intensity levels and is also equal to the number of times each LED must be turned on and off per cycle. The current method for controlling an LED display turns each row of LEDs on and off the required number of times before moving on to the next row. This conventional approach “scans” just fast enough to avoid a flicker, and the controller moves the image quickly with respect to the scan (e.g., one pixel per update).

FIG. 1 is an exemplary LED module 100 displaying a sample message, “Eat at Joe's,” in stationary form. The LED module 100 includes a number of LEDs 102. Activated LEDs 104 comprise the message “Eat at Joe's.” As above, each LED does not have its own individual drive circuit; instead, the LEDs are wired in a matrix. In the conventional method, only one row is activated at a time. The LEDs in the bottom row that are necessary to form a message are lit first, for a short period of time. Then, the necessary LEDs in the second to last row are lit. Each row up the height of the display is lit in turn, ending with the top row.

When the pattern that forms the message is shifted one column to the left in each successive scan, the eye tracks the average velocity of the moving pattern. If the height of this display is scanned 70 times per second and there are seven rows, for example, the apparent velocity will be ten columns per second. When the bottom row is lit, an image is formed on the viewer's retina. In this example, at the instant the row above is lit, the eye's gaze point has advanced one-seventh of the way toward the next column to the left. Each successive row illuminates a position on the retina that is displaced towards the next row. By the time the bottom row illuminates again, the viewer's gaze point has shifted by exactly one column. The effect of scanning combined with this kind of eye tracking is that the message on the display appears slanted. In particular, in this example, the angle is tan⁻¹ ( 1/7), or about 8 degrees. FIG. 2 shows the slanting image that results from the above-described process.

As can be seen from FIG. 2, scrolling from right-to-left will result in a slant to the right. The interaction of scanning and eye tracking has introduced a spatial artifact, which appears as a slant and causes the image to appear as italicized. The spatial artifact does not present a problem in this case because italicized writing can be readily understood, at least by most people.

As alluded to above, sharing the row and column wiring of the LEDs, commonly referred to as display multiplexing, has been used to modularly expand the size of LED displays at reduced costs. Wiring techniques have been implemented to accommodate display multiplexing and to also increase the intensity of the displayed image.

Unfortunately, a split wiring scheme affects the image if it is in eye-tracked motion. If the top and bottom halves of the display are each scanned from bottom to top, the result may appear similar to FIG. 3a, which is an LED display device in which two modules 100, 100′ (having turned off diodes 102, 102′ and turned on diodes 104, 104′, respectively) are provided and produce a visible discontinuity in the displayed message. In particular, when characters straddling a module boundary are displayed, the slant from above results in a highly visible discontinuity in the vertical elements, producing a “Z” shape rather than a line, proximate to where the character crosses a module boundary.

The spatial artifact is present not only in scrolling text, but also in moving images or animations. In such cases, jaggedness, discontinuities, flickers, flashes, and the like may be present. These problems alone or in various combinations may detract from the display and/or cause viewer confusion.

Alternative row update techniques have been implemented. For example, if the top of the display is scanned from the middle to the top, and the bottom half is scanned from middle to the bottom, the scrolling message may appear similar to FIG. 3b. However, this kind of concave image is not desirable, either.

It will be appreciated that the above example is applicable to liquid crystal display (LCD) panels, as well. Many of LED and LCD panels are not only split top-to-bottom as in FIG. 3a, but also split side-to-side, so as to form four quadrants, for example. Thus, if an image element moves across or along the joint between quadrants, it also will appear skewed.

One way to compensate for this kind of spatial artifact would be to implement faster scanning, as is commonly used for conventional television scrolling (e.g., news or stock tickers commonly displayed on news channels). While this solution may be possible for some fields, it is not feasible for LED devices. This is because the electronic parts in LED devices suffer from inherent electrical problem related, in part, to the frequency at which they may be turned on and off. Also, the electronic parts suffer from inherent electromagnetic interference (EMI) problems, which may cause the electronic parts to interfere with each other and/or with other devices proximate to the LED device.

Thus, it will be appreciated that there is a need in the art for techniques for improved techniques for displaying content (e.g., text, images, and/or like media in motion) on LED devices that include multiple LED modules.

One aspect of certain exemplary embodiments relates to a frame-based technique for displaying content on LED devices.

Another aspect of certain exemplary embodiments relates to substantially flicker-free and/or substantially continuous content across the LED modules comprising an LED device.

Yet another aspect of certain exemplary embodiments relates to techniques for manipulating an artifact created by the driving of LED modules in an LED device.

According to certain exemplary embodiments, a computer-implemented method for displaying content on an LED display device comprising a plurality of LED modules tangibly embodied in at least instructions stored on a computer readable storage medium is provided. A plurality of frames to be displayed on the LED display device across the plurality of LED modules based at least in part on the content to be displayed may be defined. Each said frame may be sequentially displayed, with each displayed frame being superimposed on the frame displayed before it. The content may be displayable substantially continuously and substantially free from flickers.

According to certain other exemplary embodiments, a computer-implemented method for displaying content on an LED display device comprising a plurality of LED modules tangibly embodied in at least instructions stored on a computer readable storage medium is provided. A plurality of frames to be sequentially displayed on the LED display device across the plurality of LED modules may be defined based at least in part on the content to be displayed. A fieldcount corresponding to a number of scans appropriate for each said frame may be defined. For each said frame, the fieldcount for the frame may be initialized. The frame may be divided into a plurality of sequentially ordered rows and columns. For each said row, in sequence, a signal may be outputted to the LED display device in dependence on the frame, the fieldcount, the row, and the column. The fieldcount may be increased and the dividing step may be repeated until all scans of the frame have been completed. The content may be displayable substantially continuously and substantially free from flickers.

According to still other example embodiments, an LED display device configured to display content across a plurality of LED modules is provided. Frame updating programmed logic circuitry may be configured to define a plurality of frames to be sequentially displayed. Field programmed logic circuitry may be configured to define a fieldcount corresponding to a number of scans appropriate for each said frame. Row displaying programmed logic circuitry may be configured to, for each said frame, cause the field programmed logic circuitry to initialize the fieldcount for the frame, divide the frame into a plurality of sequentially ordered rows and columns and for each said row, sequentially output a signal to the LED display device in dependence on the frame, the fieldcount, the row, and the column, cause the fieldcount to be increased, and repeat the frame division and the sequential output until all scans of the frame have been completed.

According to still further example embodiments, a programmable controller for use with such an LED display device is provided.

It will be appreciated that these aspects, features, and embodiments may be combined in various combinations to realize yet further exemplary embodiments.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1 is an exemplary LED module displaying a sample message, “Eat at Joe's,” in stationary form;

FIG. 2 is a snapshot of the message of FIG. 1 in motion, which produces a spatial artifact that causes the message to appear italicized;

FIG. 3a is an LED display device in which two modules are provided and produce a visible discontinuity in the displayed message;

FIG. 3b is an LED display device that updates rows from the center row, outward;

FIG. 4 is an illustrative flowchart for a frame-based update technique for displaying content (e.g., text, images, and/or like media in motion) on one or more LED modules in an LED display;

FIG. 5 is an LED display device in accordance with an exemplary embodiment;

FIG. 6 is a partial schematic view of an LED display device comprising multiple LED modules, in accordance with an exemplary embodiment;

FIG. 7 is a partial schematic view of the controlling programmed logic circuitry shown in FIG. 6, in accordance with an exemplary embodiment.

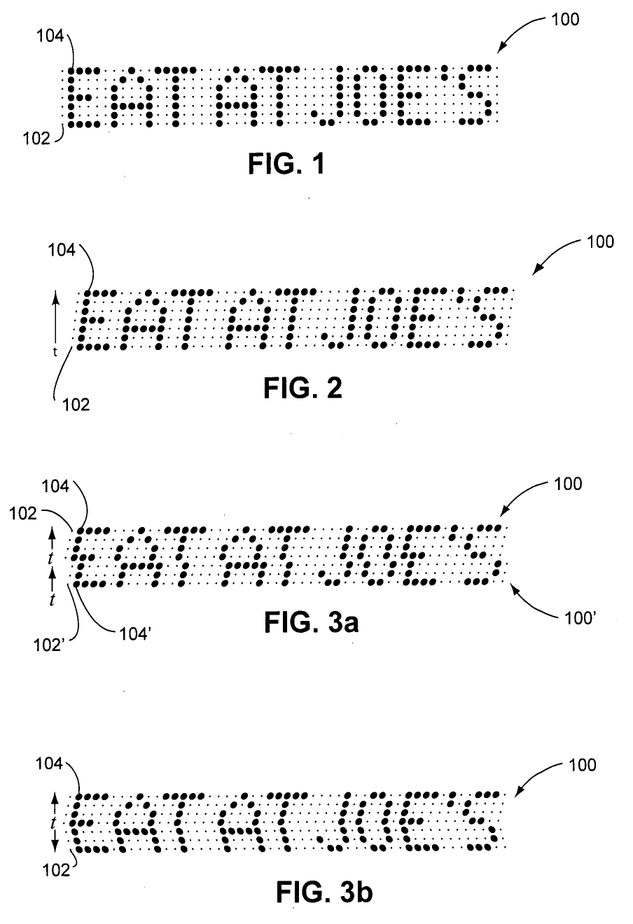

### DETAILED DESCRIPTION

Certain exemplary embodiments relate to a frame-based technique for displaying content on LED devices comprising multiple LED modules. Such embodiments may update the display one frame at a time rather than one row at a time. Accordingly, the technique may be thought of as superimposing different images on top of one another. This creates a different kind of artifact from the conventional technique. In particular, characters in a scrolling display may appear thicker (or bolded) as opposed to slanted (or italicized).

Certain exemplary embodiments may turn each LED on and off the same number of times per cycle as the conventional technique and require no change to the LED display. As such, no additional time and/or different hardware may be required to implement certain exemplary embodiments when compared to the convention techniques. Rather, the change may be in the sequence used to control the LED modules. For example, instead of turning each row on and off the required number of times before moving on to the next row, each LED in a row may be turned on or off once before moving to the next row. The row-to-row process may be repeated until all of the rows have been turned on or off the required number of times. As noted above, such techniques may produce their own distortion or artifact in the form of a thickening of the characters. The result may include substantially no discontinuities where the characters cross a module boundary and substantially no flickering of content or portions of the content. This technique thus may improve the overall appearance and/or attractiveness of the LED display device whenever horizontally scrolling characters are displayed and/or whenever graphics with motion are shown.

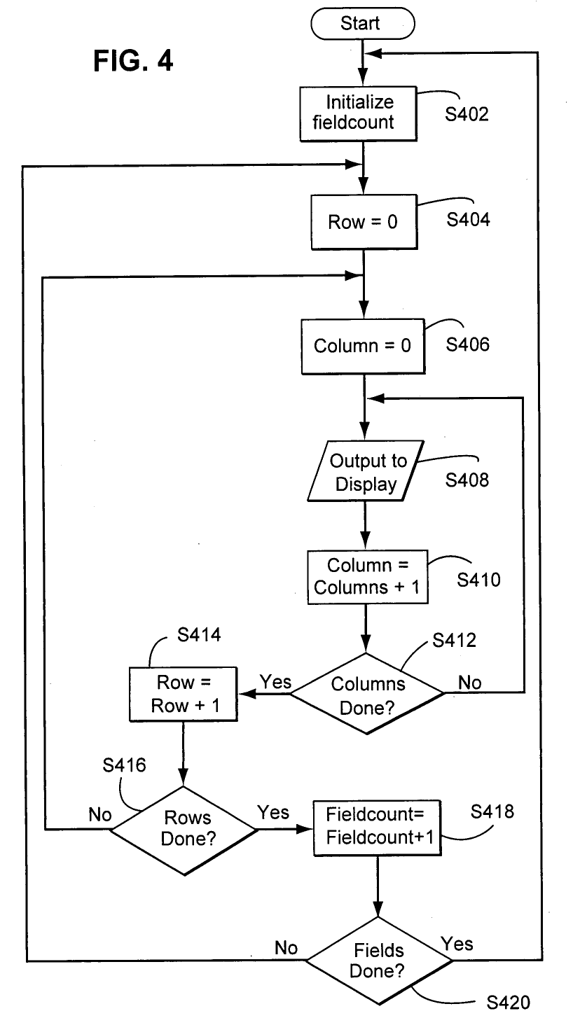

Referring now more particularly to the drawings, FIG. 4 describes this exemplary process in more detail. In particular, FIG. 4 is an illustrative flowchart for a field-based update technique for displaying content (e.g., text, images, and/or like media in motion) on one or more LED modules in an LED display. It will be appreciated that an image may be produced by scanning a complete LED display once, and each such field may not present the original image faithfully. However, multiple fields (e.g., comprising a frame) may present an improved image on the LED display. In step S402, a fieldcount is initialized. It will be appreciated that pulse-width modulation (PWM) may be used to control the intensity of the display and that the field count initialization will depend, in part, on the particular type of LED selected for implementation. For example, for standard red-green-yellow (RGY) displays, each frame may comprise 16 fields. In another example, red-green-blue display may use 32 fields. In general, in certain exemplary embodiments, a 60 Hz frame rate may result in substantially no flicker. Of course, displays other than RGY displays may be implemented, and different frame rates (e.g., faster or slower) may be implemented.

The row count is set to 0 in step S404, and the column count is set to 0 in step S406. The initial row and column accordingly are ready to receive output, and output is sent to the display in step S408. The output may take the form of a signal instructing a particular LED to turn on or off. The signal also may indicate a length that the LED should be on or off. The column count is incremented in step S410. If all columns in the particular row have not been updated as determined by step S412, the process returns to step S408 so that the next column in the particular row may be updated.

When all columns in the row have been updated as determined by step S412, the row count is updated in step S414. If all rows are not updated as determined by step S416, then the process returns to step S404 so that all columns in the next row may be updated. Once all rows have been updated as determined by step S416, a single image effectively will be displayed across all modules. In step S418, the fieldcount is incremented. If the frame is not completed (e.g., the image needs to be scanned again) as determined by step S420, the image will be rescanned by returning the process to step S404. If, however, the scanning is completed as determined by step S420, the process is ready to proceed to the next frame and returns to step S402, accordingly.

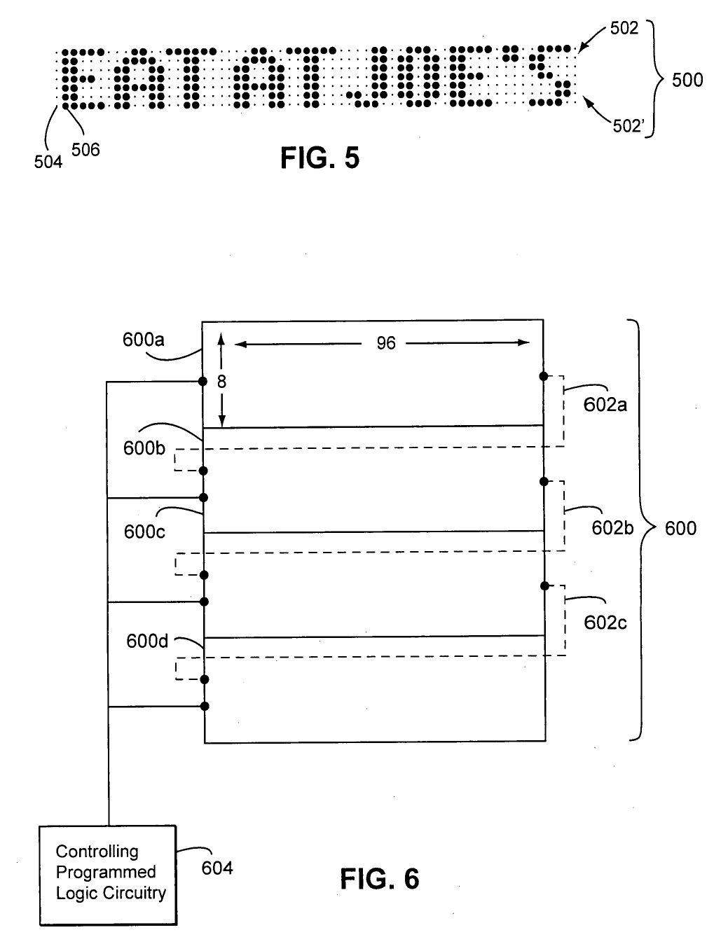

FIG. 5 is an LED display device in accordance with an exemplary embodiment. In FIG. 5, two LED modules 502, 502′ are provided. Each LED module includes a number of LEDs 504 and activated LEDs 506. The activated LEDs 506 spell out “Eat at Joe's” similar to the conventional example. However, as will be appreciated from FIG. 5, the text appears bolder. This is related to the artifact caused by the frame-based update of the LED modules.

FIG. 6 is a partial schematic view of an LED display device 600 comprising multiple LED modules 600a-d, in accordance with an exemplary embodiment. In FIG. 6, each module is 96 dots wide by 8 dots high. Although these dimensions are typical of LED modules, it will be appreciated that the present invention is not limited to this type of LED module or any particular class of modules. For example, one particular LED display device that may be used in connection with certain exemplary embodiments is the PAL212 64×8 RGB Display available from Paltronics. The modules 600a-d are connected via connections 602a-c and are shown as being electrically in series. Of course, it will be appreciated that more or fewer LED modules may be provided to the overall LED display. For example, LED modules may be provided “down” and/or “across” to create a longer and/or wider display.

Controlling programmed logic circuitry 604 is provided for driving the LED display and/or the LED modules individually or in groups, for example, in accordance with the above-described techniques. The controlling programmed logic circuitry 604 may be implemented as hardware, software, firmware, and/or any other suitable form of programmable device capable of receiving and executing instructions. Of course, it will be appreciated that the content to be displayed may be input into, and/or accessed by, the controlling programmed logic circuitry 604. This may be accomplished by reading data from and/or writing data to any suitable computer-readable storage medium.

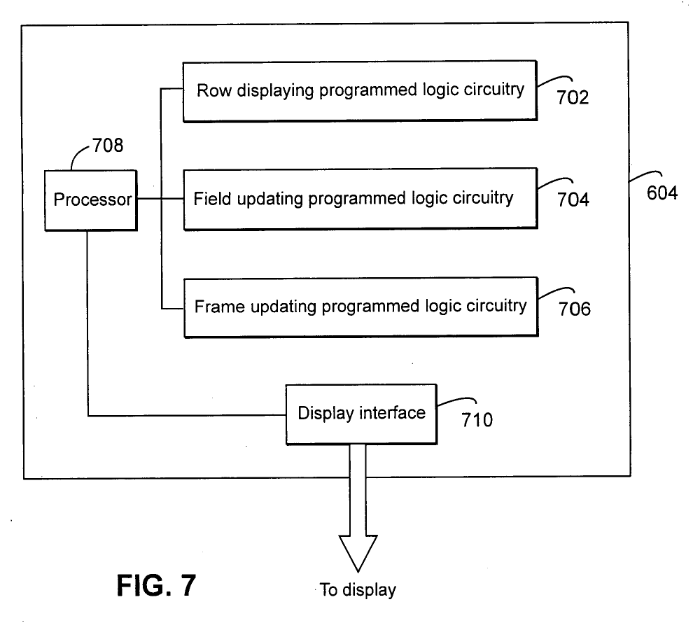

FIG. 7 is a partial schematic view of the controlling programmed logic circuitry 604 shown in FIG. 6, in accordance with an exemplary embodiment. Row displaying programmed logic circuitry 702 may be configured to output (e.g., turn on or off) each pixel, row-by-row. Once an image is displayed by the row displaying programmed logic circuitry 702, field displaying programmed logic circuitry 704 may be configured to pulse-width modulate the image, e.g., by changing a fieldcount, thus allowing the row displaying programmed logic circuitry 702 to re-display the image using the new fieldcount. Frame updating programmed logic circuitry 706 may be configured to define a new frame after all fields are displayed. A processor 708 may be configured to coordinate interactions among and/or between the row displaying programmed logic circuitry 702, the field displaying programmed logic circuitry 704, and/or the frame updating programmed logic circuitry 706, as appropriate. The processor 708 also may instruct a display interface 710 to output the appropriate information to the LED modules.

Although certain exemplary embodiments have been described as relating to LED display devices, the present invention is not so limited. For example, certain exemplary embodiments may be implemented and/or adapted for use with other display devices such as, for example, LCD display devices, CRT display devices, movie projectors, etc. Also, it will be appreciated that the configurations and arrangements of the LED modules described herein are provided by way of example and without limitation.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A computer-implemented method for displaying content on an LED display device comprising a plurality of LED modules tangibly embodied in at least instructions stored on a computer readable storage medium, the method comprising:
defining a plurality of frames to be displayed on the LED display device across the plurality of LED modules based at least in part on the content to be displayed; and
sequentially displaying each said frame, each displayed frame being superimposed on the frame displayed before it,
wherein the content is displayable substantially continuously and substantially free from flickers.

2. The method of claim 1, wherein the plurality of LED modules are connected in series.

3. The method of claim 1, further comprising controlling each said displayed frame's intensity via a plurality of fields for pulse-width modulation.

4. The method of claim 3, further comprising providing a full color display.

5. The method of claim 1, further comprising for each said frame, defining a plurality of scans based on fields of the frame, the plurality of scans to be displayed in sequence before the next frame is displayed.

6. The method of claim 1, wherein the content corresponds to scrolling text and/or an image in motion.

7. A computer-implemented method for displaying content on an LED display device comprising a plurality of LED modules tangibly embodied in at least instructions stored on a computer readable storage medium, the method comprising:
defining a plurality of frames to be sequentially displayed on the LED display device across the plurality of LED modules based at least in part on the content to be displayed;
defining a fieldcount corresponding to a number of scans appropriate for each said frame; and
for each said frame,
initializing the fieldcount for the frame;
dividing the frame into a plurality of sequentially ordered rows and columns and for each said row, sequentially outputting a signal to the LED display device in dependence on the frame, the fieldcount, the row, and the column, and
increasing the fieldcount and repeating the dividing step until all scans of the frame have been completed;
wherein the content is displayable substantially continuously and substantially free from flickers.

8. The method of claim 7, wherein the plurality of modules are connected in series.

9. The method of claim 7, wherein the content corresponds to scrolling text and/or an image in motion.

10. An LED display device configured to display content across a plurality of LED modules, comprising:
frame updating programmed logic circuitry configured to define a plurality of frames to be sequentially displayed;
field programmed logic circuitry configured to define a fieldcount corresponding to a number of scans appropriate for each said frame; and
row displaying programmed logic circuitry configured to, for each said frame:
cause the field programmed logic circuitry to initialize the fieldcount for the frame,
divide the frame into a plurality of sequentially ordered rows and columns and for each said row, sequentially output a signal to the LED display device in dependence on the frame, the fieldcount, the row, and the column,
cause the fieldcount to be increased, and
repeat the frame division and the sequential output until all scans of the frame have been completed.

11. The LED display device of claim 10, wherein the plurality of modules are connected in series.

12. The LED display device of claim 10, wherein the field programmed logic circuitry is further configured to control frame intensity via pulse-width modulation.

13. The LED display device of claim 10, wherein the field programmed logic circuitry is further configured to accommodate a full color display.

14. The LED display device of claim 10, wherein the content corresponds to scrolling text and/or an image in motion.

15. The LED display device of claim 10, wherein the row displaying programmed logic circuitry is further configured to display the plurality of frames at a rate of 60 Hz.

16. The LED display device of claim 10, wherein the row display programmed logic circuitry is further configured to cause the content to be displayed substantially continuously and substantially free from flickers.

17. A programmable controller for use with the display device of claim 10.

18. A gaming machine incorporating the display device of claim 10.

19. A progressive jackpot gaming system incorporating the display device of claim 10.
